(19) United States
(12) Patent Application Publication
(10) Pub. No.: US 2017/0270719 A1
(43) Pub. Date: Sep. 21, 2017

(54) BICYCLE SERVICING SYSTEM AND BICYCLE SERVICING METHOD

(71) Applicant: Deutsche Telekom AG, Bonn (DE)

(72) Inventors: Sebastian Wegerle, Urbar (DE); Benedikt Zeindl, Schoellnach (DE); Wilfried Huelsmann-Tennhoff, Oldenburg (DE); Markus Rau, Neu-Ulm (DE); Markus Lindemann, Bonn (DE); Thomas Eckert, Flieden (DE); Claudia Lippmann, Bonn (DE); Joerg Winkler, Roemerstein (DE)

(73) Assignee: Deutsche Telekom AG, Bonn (DE)

(21) Appl. No.: 15/505,934

(22) PCT Filed: Aug. 20, 2015
(86) PCT No.: PCT/EP2015/069127

§ 371 Date: Feb. 23, 2017

(30) Foreign Application Priority Data
Aug. 26, 2014 (DE) 10 2014 216 966.6

(51) Int. Cl. G07C 5/08; B62H 5/20; G07C 5/00

(52) U.S. Cl. CPC G07C 5/0808; G07C 5/008; B62H 5/20; B62J 2099/004

(57) ABSTRACT

A bicycle servicing system includes: a transceiver device for arrangement on a bicycle; a bicycle data processing device arranged on the bicycle and connected with the transceiver device; a stationary data processing device for processing bicycle- and/or cyclist-specific data received from the transceiver device, the data processing device being adapted to be in communication with the transceiver device via mobile data transmission; and a data output device for outputting data transmitted from the data processing device, the data output device being adapted to be in communication with the data processing device via mobile data transmission, and/or a further data processing device for further processing of the data transmitted from the data processing device, the further data processing device being adapted to be in communication with the data processing device via data transmission.

### CROSS-REFERENCE TO RELATED APPLICATIONS

This application is a U.S. National Phase application under 35 U.S.C. §371 of International Application No. PCT/EP2015/069127, filed on Aug. 20, 2015, and claims benefit to German Patent Application No. DE 10 2014 216 966.6, filed on Aug. 26, 2014. The International Application was published in German on Mar. 3, 2016 as WO 2016/030267 A1 under PCT Article 21(2).

### FIELD

The invention relates to a bicycle servicing system, as well as to a bicycle servicing method.

### BACKGROUND

For bicycles, in particular highly stressed bicycles, it is regularly necessary to perform maintenance thereon such that, in regular intervals, e.g. brake pads are exchanged, the chain is replaced, bearings are lubricated etc. This is necessary in particular with bicycles used for sports activities. It is desirable for a user that it is ensured in particular during competitions and also during extended tours that in particular no significant maintenance is required.

### SUMMARY

In an exemplary embodiment, the invention provides a bicycle servicing system. The bicycle servicing system includes: a transceiver device for arrangement on a bicycle; a bicycle data processing device arranged on the bicycle and connected with the transceiver device; a stationary data processing device for processing bicycle- and/or cyclist-specific data received from the transceiver device, the data processing device being adapted to be in communication with the transceiver device via mobile data transmission; and a data output device for outputting data transmitted from the data processing device, the data output device being adapted to be in communication with the data processing device via mobile data transmission, and/or a further data processing device for further processing of the data transmitted from the data processing device, the further data processing device being adapted to be in communication with the data processing device via data transmission.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic diagram of a bicycle servicing system; and

FIG. 2 is a schematic illustration of an exemplary arrangement of a transceiver device in a bicycle frame.

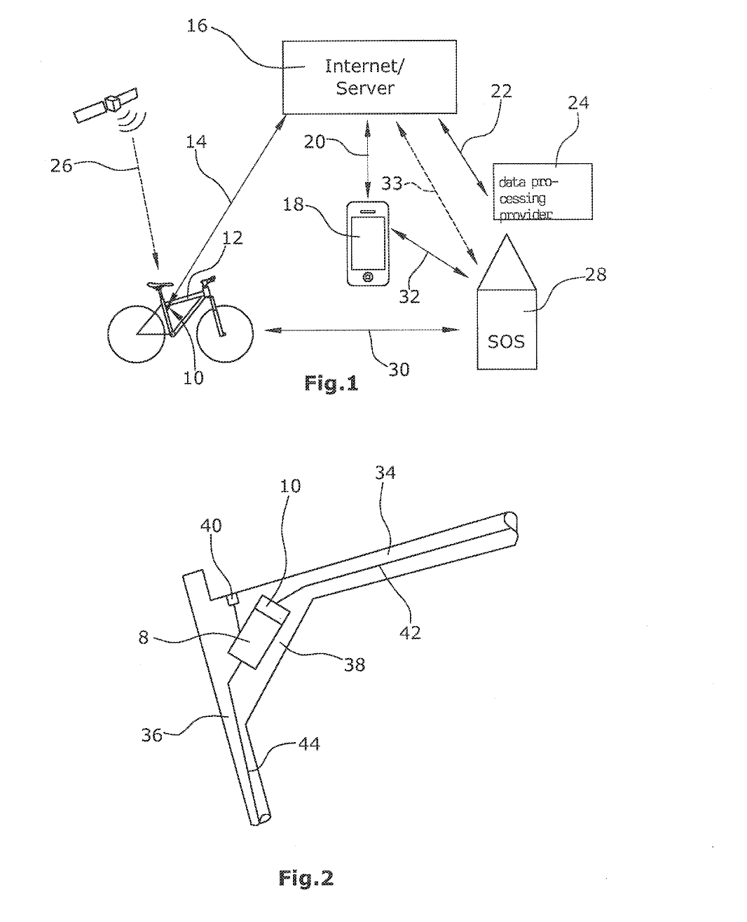

### DETAILED DESCRIPTION

Exemplary embodiments of the present invention provide a bicycle servicing system by which it is possible in particular to determine in a simple manner when maintenance has to be performed.

Exemplary embodiments of the present invention, independent of or in addition to simplifying maintenance and servicing, also increase safety. Exemplary embodiments of the present invention also provide tour data, training data and the like to a cyclist in a simple manner.

The bicycle servicing system of the present invention comprises a transceiver device to be arranged on a bicycle. The device may be arranged directly on the bicycle frame or be integrated in the same, but may also be arranged, at least in part, at the handlebar, the seat, the seat tube or the like. Further, a bicycle data processing device is arranged on the bicycle, in particular immediately on the bicycle frame. The latter device is connected with the transceiver device. The transceiver device first serves to transmit data to a stationary data processing device. Data are transmitted by mobile data transmission so that the stationary data processing device may be a stationary data processing device including computers etc. which is arranged independently from the bicycle, e.g. centrally. The stationary data processing device serves to process the data received from the transceiver. In a simple embodiment it is sufficient for the device to be a pure transmitting device that cannot receive data, with a transceiver unit being preferred. In particular, the bicycle data processing device is a so-called On Board Unit. The same serves to process and treat data which are then transmitted to the stationary data processing device via the transceiver devices. The data treated and processed by the bicycle data processing device may be sensor data, data acquired by a bicycle computer, tour data, cyclist-specific data etc.

According to the invention the data processed by the stationary data processing device are transmitted—in a preferred embodiment of the invention—to a data output device, again by mobile data transmission, in particular to a mobile phone, a tablet or the like. At the data output device, the data appropriately processed and transmitted by the data processing device are outputted.

As an alternative or in addition to the transmission of the processed data to a data output device, the data may also be transmitted to another computer or server in particular via the Internet. Such a further data processing device may be e.g. a data processing device of a service provider. This may e.g. be a provider of map material that uses the data acquired by the bicycle servicing system to improve the quality of the data material, etc.

For a reliable data transmission the transceiver preferably comprises a modem, in particular a Global System for Mobile communication (GSM) modem. In this case the data are preferably transmitted to the data processing device, although it is possible in a preferred embodiment to also transmit at least part of the data directly to the data output device. The transceiver device preferably comprises a power source. This may be an accumulator which is connected e.g. with a plug contact for connection of a charging device. Charging the accumulator could e.g. also be achieved via solar cells or a generator that is connected e.g. with the pedal crank.

Further, it is preferred that the transceiver device comprises a Global Positioning System (GPS) module or is connected with a GPS module. It is possible in particular through a connection with a GPS module to receive and determine a variety of data. The GPS data may be transmitted in large time intervals or continuously to the data processing device by mobile data transmission. From the GPS data, the data processing device can detect, among others, the speed, the distance covered, the track, the elevation profile etc. These data may then be transmitted to the data output device via the system according to the present invention. Using the data output device, which in particular is a mobile phone, the cyclist can retrieve the corresponding data in a simple manner.

Already when providing a GPS module it is possible for the data processing device to determine maintenance cycles. These may e.g. merely depend on a certain mileage. In addition, corresponding algorithms may also consider the difference in altitude covered and possibly even the gradient. Using a corresponding algorithm it would e.g. be possible to take into consideration that the chain and the brake pads are possibly stressed much more depending on the difference in altitude covered and the gradient, so that servicing or maintenance are recommended already at a lower mileage. Moreover, it is particularly preferred that the determination of maintenance cycles is performed independently of a data input by a user. The determination of maintenance cycles or similar information is preferably performed exclusively on the basis of data automatically determined by the system.

It is possible in particular upon the transmission of maintenance recommendations to additionally transmit data regarding e.g. the bicycle-specific brake pads, the chain used etc. This is possible once corresponding information has been input by the user or already by the manufacturer. Further, it is possible to direct the cyclist immediately to an Internet site on which the spare parts required for maintenance can be ordered. In addition, the cyclist may be provided e.g. with assembly or maintenance instructions via the Internet.

In another preferred embodiment of the bicycle servicing system sensors are arranged on the bicycle. These serve in particular to obtain bicycle-specific data. The sensors may be a sensor for speed detection arranged at the front or the rear wheel, a REED sensor for detecting pedal crank movement, gradient sensors and the like. The corresponding bicycle-specific data are transmitted to bicycle data processing device by the sensors and are processed or treated by said device and are then transmitted to the stationary data processing device for further processing. Further, cyclist-specific data such as the pulse can be obtained in particular in a wireless manner and may also be transmitted to the data processing device. For example, an acceleration sensor may be provided. With such a sensor it is possible to determine the ground on which the bicycle moves. By providing a magnetic field sensor it is possible e.g. to determine, whether the bicycle moves on concrete or on a bridge.

In particular it is possible to provide a sensor on the bicycle to detect a fall. This may e.g. a sensor that detects the vibration. In particular when a cyclist is riding all alone, safety can be increased significantly thereby. When a fall is detected an emergency call can be sent immediately. This may be effected via the stationary data processing device or directly via a mobile phone carried along or via the transceiver device itself. In this regard it is preferred that GPS data are also transmitted immediately to a corresponding emergency call center. Further, the emergency call center could automatically activate a return call to contact the cyclist and, if necessary, initiate the appropriate required rescue operations.

In a first step a bicycle servicing method, which in a preferred embodiment is performed using the above described bicycle servicing system, acquires bicycle- and/or cyclist-specific data. Data acquisition is performed in particular as described above with reference to the bicycle servicing system via sensors arranged on the bicycle or on the cyclist, a GPS module and the like. The data obtained are then first transmitted to the bicycle data processing device arranged on the bicycle. The same processes or treats the data. Thereafter, the data are transmitted by mobile data transmission to a stationary data processing device for further processing. The processed are then transmitted to a data output device, again by mobile data transmission, and are outputted via the data output device. As an alternative or in addition to an output of data at a data output device, the data are transmitted from the stationary data processing device to a further data processing device, e.g. a server of a provider. The same performs a further processing of the data, wherein these data may possibly also be transmitted to the data output device of the user or the cyclist. This is effected in particular as described above with reference to the bicycle servicing system. Using this method, the data transmitted are in particular geo data, typical speedometer data such as speed, gradient etc., as well as pedal crank data regarding the crank movement.

On the basis of the transmitted data and, if applicable, on the basis of data additionally stored in the bicycle data processing device and/or the stationary data processing device, data regarding maintenance work to be performed and the like are transmitted to the data processing device and/or the further data processing device. Preferably, the usual speedometer data, statistics, trekking data etc. are transmitted to the latter devices. Via the in particular mobile data output device, it is possible to further provide data for an immediate ordering of spare parts, assembly and maintenance instructions and the like.

It is particularly preferred to automatically start the data acquisition and/or the data processing and/or the data transmission as soon as the bicycle is moved. Via the sensors provided, it is possible to detect in a simple manner that the bicycle is moved. This may be effected via the GPS module, the REED sensor, the speed sensor and the like.

Further, it is preferred that, using the bicycle servicing method, data related to a fall are detected as described above with respect to the system and that an emergency call is made immediately.

The invention further relates to a bicycle with a transceiver device for performing the above described method. In this case, the transceiver device is preferably integrated at least partially in the bicycle frame. The transceiver device may be arranged in particular in the top tube and/or the seat tube and/or a corresponding connecting element between these two frame elements. This has the advantage that the transceiver is easily accessible. In this respect it is possible to provide a connector for plugging in a charging cable for an integrated accumulator, a Universal Serial Bus (USB) connector and the like. It is also possible to connect the transceiver device with the corresponding sensors via cables placed in particular in the frame.

In an exemplary embodiment, an automatic detection and monitoring of service intervals is possible. In particular, a user does not have to set maintenance intervals manually, but the detection is performed on the basis of data inputted in advance, components built in, as well as on the basis of known data about retrofitted components or spare parts. Thus, an automatic bicycle-specific determination of service intervals is performed which, as described above, may be made in particular in dependence on the way the bicycle is used. The user may be notified not only via a data output device like a smart phone or the like, but e.g. also by sending an e-mail, by transmitting the data to a bicycle computer or the like.

In a preferred embodiment, parts and components of the bicycle are monitored automatically by sensors on or in the bicycle, and the data acquired are automatically transmitted to the bicycle data processing device, in particular the On Board Unit. An evaluation of the data may then be performed at least in part already in the On Board Unit or afterwards in the stationary or further data processing device. Preferably, an intervention by the user is not required. Besides the sensors described above, tire pressure sensors, sensors in the gearing system, measuring strips in the frame etc. may also be provided.

Another possible operating option of the invention is to use the same as an anti-theft device. For this purpose it is possible for example that a user of the bicycle has to identify himself before use of the bicycle. This may be effected e.g. via a smart phone, a PIN to be inputted and the like. If no appropriate authentication is performed, the bicycle will send corresponding theft indication signals if the bicycle receives a theft impulse, i.e. for example when it is moved. In this case, in particular position data may be transmitted so that tracking etc. is possible.

The bicycle data processing device, in particular even the On Board Unit, may also be used as an autonomously operated unit which is an independent invention. Such bicycle data processing device is connected in particular with a plurality of sensors and processes the received data immediately. The stored data may then be read out e.g. via an interface or via wireless local area network (WLAN). A corresponding evaluation of the data may then be made on a private personal computer (PC) or by transmission to stationary data processing devices such as servers on the Internet.

The bicycle servicing system of the present invention is suited in particular also for e-bikes and bicycles with electric drives, wherein this offers additional possibilities of use. The transceiver device arranged in the bicycle is connected with the bicycle data processing device which may also take the state of the accumulator into account. In this case, not only the state of the accumulator may be taken into account and transmitted, but also general data on the state of the accumulator. In as far as e.g. the charging capacity of the accumulator decreases due to its age, this may be detected and a timely replacement of the accumulator can be suggested to the user. Since modem electric drives are controlled via software, it is another significant advantage of the invention that this software can be updated in a simple manner. This may be effected via the transceiver device connected with the bicycle. In particular, it is therefore not necessary to visit a repair shop or a bicycle store or to establish a wire connection with the Internet for a software update.

Another advantageous possible use of the bicycle servicing system of the present invention relates to fleet management. For example, bicycle renting firms may in particular retrieve the data required for service intervals at any time. It could then be ensured via appropriate software that the bicycles of the entire fleet are each serviced in time. In this case, a plurality of data measured, such as e.g. the distance covered, may be taken into account.

Such fleet management is also advantageous in particular with bicycles with an electric drive. For example, in larger fleets, the accumulators of such e-bikes are presently replaced in regular intervals of 1.5 years. This is a precautionary measure that, however, does not consider the actual state of the accumulator. Upon obtaining corresponding accumulator data, it is possible e.g. to check the ageing of an accumulator individually. As a result, the accumulator is replaced only when necessary.

Basically, besides detecting periods of use and distances, it is possible to perform a route optimization, for example. This is advantageous e.g. for mail courier services.

Besides the use of the bicycle servicing system in the direct sale of bicycles, the system is also advantageous for dealers, since it allows the promotion of a two-stage selling. The communication between a dealer and a customer can thus be significantly enhanced. If the corresponding data obtained by the bicycle servicing system are transmitted to the dealer, the latter may e.g. provide automatic maintenance notes to the customer. Further, a dealer can provide help faster e.g. in case of breakdown. Moreover, it is possible to set up bonus programs. A customer may further be provided with exact knowledge about the actual use of the bicycle. This is of interest in particular in case of city bikes, since a customer is often unaware of the actual use of a bicycle and often underestimates the same. As a result, e.g. the chain, brake pads and the like are often replaced too late so that consequential damages may occur.

The invention will be described in detail hereunder with reference to a preferred embodiment and to the accompanying drawings.

The bicycle servicing system of the present invention comprises a transceiver device 10 which, for example, is integrated in a bicycle frame 12. The transceiver device 10 is connected with a bicycle data processing device 8. The transceiver device 10 transmits data via mobile data transmission, as illustrated by an arrow 14, to a stationary data processing device 16. The in particular local, not mobile data processing device also comprises transceiver devices, as well as processing devices such as computers and the like. Optionally, data transmission from the data processing device 16 to the transceiver device 10 is possible as well.

The bicycle data processing device 8 is connected with different sensors e.g. via electric cables 42, 44, said sensors being arranged on the bicycle and/or on the cyclist. The corresponding connection may also be designed as a wireless connection.

In a preferred embodiment, first a processing or treatment of the data obtained by the sensors is performed by the bicycle data processing device 8. The processed or treated data are then transmitted to the data processing device 16 or an Internet server by the transceiver device 10.

Usually, the processed or treated data are transmitted from the data processing device 16 to a data output device 18 such as a mobile phone. The data are again transmitted via mobile data transmission, as illustrated by an arrow 20, wherein it is optionally also possible to transmit data from the data output device 18 to the data processing device 16. These data may e.g. be data inputted by the user or data acknowledging a clear reception of the transmitted data etc.

The data outputted on the mobile phone 18 relate e.g. to trekking data, data about the track, the mean speed, the maximum speed, the mean maximum gradients etc., as well as, if applicable, statistics or overviews generated therefrom. Representations may of course also be in the form of representations on a map, altitude profiles, curves, graphs etc.

In particular, the data processing device acquires maintenance data, preferably on the basis of stored bicycle-specific data. The data relate e.g. to the brake pads mounted in the corresponding bicycle, the chain mounted, the type of bicycle (racing bicycle, mountain bike, trekking bike etc.) and the like. Using the mobile phone 18 or a corresponding data output device a mobile data connection or a connection with the Internet 16 can be established. This is advantageous in that e.g. a link to an ordering module, service and assembly instructions and the like can be realized immediately.

The data processing device 16, such as e.g. a server of the bicycle manufacturer or the like, can transmit the received and possibly processed data to a further data processing device 24. This may be a provider of services who uses the corresponding data for that purpose.

Further, it is possible that the transceiver device 10 receives GPS data (arrow 26) and transmits these to the data processing device.

Further data can be obtained in particular through sensors provided on the bicycle and be transmitted to the data processing device by the transceiver. It is a particularity of the present invention that at least one sensor can be provided that detects a fall. The sensor may e.g. detect strong vibrations. In the event of a fall an emergency call is issued immediately. The same may be sent immediately to an emergency call center 28 as illustrated by an arrow 30. The emergency call may of course also be made via the data processing device 16 (arrow 33) and/or the mobile phone 18 (arrow 32). In particular in the event of an emergency call, direct communication between the transceiver device 10 and the mobile phone 18 can also occur.

The transceiver 10 may in particular be integrated in the bicycle frame 12. An arrangement in the top tube 34 or a seat tube 36 (FIG. 2) is particularly suitable. Since the transceiver device possibly requires a little more space, the transceiver device 10 may also be arranged in a connecting element 38 between the top tube 34 and the set tube 36. In this area it is further possible in a simple manner to provide e.g. a plug contact 40 for plugging in a charging device or a USB connector and the like. The transceiver device 10 is connected with sensors e.g. via electric cables 42, 44. Moreover a connection to an antenna may be provided via a corresponding cable, so as to arrange the same in a corresponding region of the bicycle frame for a data transmission as error-free as possible. Further, the transceiver 10 may be connected with a current generator via corresponding cables, said generator being arranged e.g. in the bottom bracket.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A bicycle servicing system, comprising:
a transceiver device for arrangement on a bicycle;
a bicycle data processing device arranged on the bicycle and connected with the transceiver device;
a stationary data processing device for processing bicycle- and/or cyclist-specific data received from the transceiver device, the data processing device being adapted to be in communication with the transceiver device via mobile data transmission; and
a data output device for outputting data transmitted from the data processing device, the data output device being adapted to be in communication with the data processing device via mobile data transmission, and/or
a further data processing device for further processing of the data transmitted from the data processing device, the further data processing device being adapted to be in communication with the data processing device via data transmission.

2: The bicycle servicing system of claim 1, wherein the transceiver device comprises a Global System for Mobile communication (GSM) modem for transmitting and receiving data to and from the stationary data processing device.

3: The bicycle servicing system of claim 1, wherein the transceiver device and the bicycle data processing device comprise a power source.

4: The bicycle servicing system of claim 1, wherein the transceiver device comprises a Global Positioning System (GSM) module or is connected with a GPS module.

5: The bicycle servicing system of claim 1, wherein the bicycle data processing device is connected with sensors to be arranged on the bicycle for obtaining bicycle-specific data and/or with sensors to be arranged on a cyclist for obtaining cyclist-specific data.

6: A bicycle servicing method, comprising:
obtaining bicycle-specific and/or cyclist-specific data via sensors arranged on a bicycle frame and/or a cyclist;
transmitting the data to a bicycle data processing device;
transmitting the data via a transceiver device by mobile data transmission to a stationary data processing device, the transceiver device being connected with the bicycle data processing device;
transmitting the data processed by the stationary data processing device to a data output device by mobile data transmission and/or to a further data processing device by data transmission; and
outputting the data via the data output device or processing the data further by the further data processing device.

7: The bicycle servicing method of claim 6, wherein the data transmitted by the transceiver device to the stationary data processing device includes geo data, speed data and/or pedal crank data.

8: The bicycle servicing method of claim 6, wherein the stationary data processing device transmits data regarding maintenance to be performed on the bicycle to the data output device based on the data received from the transceiver.

9: The bicycle servicing method of claim 6, wherein the data acquisition and/or the data processing and/or the data transmission are started automatically when the bicycle is moved.

10: The bicycle servicing method of claim 6, wherein an emergency call is issued in response to data related to a fall being detected by the bicycle data processing device.

11: A bicycle, comprising:
the bicycle data processing device; and
the transceiver for performing the bicycle servicing method of claim 6.

12: The bicycle of claim 11, wherein the transceiver device and/or the bicycle data processing device are at least partly integrated in the bicycle frame.

13: The bicycle of claim 12, wherein the transceiver device is arranged in a top tube and/or a seat tube and/or a connecting element connecting the top tube and the seat tube.
